(19) United States
(12) Patent Application Publication
(10) Pub. No.: US 2008/0141042 A1
(43) Pub. Date: Jun. 12, 2008

(54) Memory card and security method therefor

(75) Inventor: Jen-Wei Lo, Hsinchu (TW)

Correspondence Address: BACON & THOMAS, PLLC, 625 SLATERS LANE, FOURTH FLOOR, ALEXANDRIA, VA, 22314, US

(73) Assignee: Phison Electronics Corp., Hsinchu (TW)

(21) Appl. No.: 11/636,486

(22) Filed: Dec. 11, 2006

(51) Int. Cl. G06F 12/14

(52) U.S. Cl. 713/193

(57) ABSTRACT

The invention presents a memory card for use with a computer installed with an operating system (OS), comprising a first memory area for storing a key code; a second memory area for storing contents encrypted with the key code; and a third memory area for storing a content protection program including a decryption application program (AP) for decrypting the encrypted contents after the decryption AP is loaded to the OS.

### FIELD OF THE INVENTION

The present invention relates to a content card, and more particularly, to a memory card and a security method therefor.

### BACKGROUND OF THE INVENTION

During the last several decades, computer storage media technology is evolving rapidly. A number of new applications for those computer storage devices have emerged, and many of these include need for security of information stored in the computer storage devices.

Please refer to FIG. 1. It illustrates a secure flash memory device according to the prior art. As shown in FIG. 1, the secure flash memory device 10 is connected to the computer 40 using the connection port 14. The secure flash memory device 10 further comprises a flash memory 20 and a microcontroller 22, wherein the flash memory 20 can be partitioned and is used to store data. The microcontroller 22 includes a small memory 24, which can be a random access memory (RAM) or a read only memory (ROM). The microcontroller 22 also controls the flash memory device 10 by accepting commands and requests from the computer 40 and controlling and regulating access to the flash memory 20 by the computer 40. Specifically, the microcontroller 22 interprets flash memory access requests issued by the computer 40 and controls the flash memory 20 accordingly.

There is a security program 28 stored in the flash memory 20, wherein the security program 28 uses a small amount of space leaving the remainder of the flash memory 20 available to be used as a bulk storage area 30. The security program 28 works in conjunction with a predetermined pass code 32 stored in the memory 24 of the microcontroller 22 to direct the microcontroller 22 to either allow or prevent data to flow between the flash memory 20 and the computer 40 connected to the connection port 14. The predetermined pass code 32 can be encrypted, to further prevent unauthorized access to the flash memory 20. The security program 28 can also include code that allows the predetermined pass code 32 to be modified by a user. Additionally, the security program 28 can control the graphical user interface (GUI) of the computer 40 to provide a user-friendly interface. When the user wishes to use the secure flash memory device 10, the user simply plugs the connection port 14 into the corresponding connection port of the computer 40. In practical application there are many procedures executed by the computer 40 to ensure a proper connection to the secure flash memory device 10, however, these are well know in the art. The prior art provides a security program that controls how a microcontroller provides access to a flash memory. When the user wishes to read data from or write data to the secure flash memory device 10, the user requests read or write access to the flash memory 20 via the computer 40. Meanwhile, this request is detected by the microcontroller 22, and the microcontroller 22 instructs the computer 40 to execute the security program 28. The security program 28 then prompts the user to enter a pass code. The pass code entered by the user is compared to the predetermined pass code 32 stored in the memory 24 of the microcontroller 22. If the entered pass code matches the predetermined pass code 32, the microcontroller 22 allows access to the flash memory 20 by the computer 40. The user may now read and write information to the bulk storage partition 30 of the flash memory 20. If the entered pass code doesn't match the predetermined pass code 32, the microcontroller 22 prevents access to the flash memory 20 by the computer 40. The user may not access the bulk storage partition 30 of the flash memory 20. According to the prior art, the security program 28 compares the entered pass code to the predetermined pass code 32. The microcontroller 22 then allows or restricts access to the bulk storage area 30 of the flash memory 20 in accordance with the verification of the entered pass code. The user can request read or write access to the flash memory 20 by executing the security program 28, or performing another similar action. However, the security program 28 is unable to keep filtering OS of the computer 40. After the bulk storage area 30 of the flash memory 20 is accessed, OS of the computer 40 could perform the flash memory 20 without further limitation. In this situation, the predetermined pass code 32 or the content of the flash memory 20 could be acquired or modified, because the predetermined pass code 32 of the prior art is allowed to be modified by a user. Obviously, the security system of memory card could be ridded easily according to the prior art.

Therefore, in practice, the prior art could not provide the memory card with entire security. Hence, it needs to provide a memory card with an effective security method to avoid the risk of unintended access to private data. Unlike conventional memory encryption devices (such as the memory apparatus of U.S. application Ser. No. 10/064,414 to Chiao et al.), the present invention does not act transparently or allow arbitrary read or write operations and rectify those drawbacks of the prior art and solve the above problems.

### SUMMARY OF THE INVENTION

Accordingly, the prior art is limited by the above problems. It is an object of the present invention to provide a memory card for use with a computer installed with an OS, wherein the content protection program with a decryption AP and OS limiter is introduced to either allow or prevent data to flow between the memory card and the computer while the memory card is plugged into a computer, and the present invention is capable of avoiding unintended or ignorant authorization to access the contents.

In accordance with an aspect of the present invention, the memory card includes a protected memory block for storing a key code and contents encrypted by the key code, and a storage block for carrying content protection program having a decryption application program (AP) for decrypting the encrypted contents and an operating system (OS) limiter for deactivating predetermined functions of the OS. Once the decryption AP and the OS limiter of the content protection program are loaded to the OS, the OS gains access to the encrypted contents after the decryption AP retrieves the key code from the protected memory block. Furthermore, the OS is controlled by the OS limiter.

Preferably, the memory card comprises a USB PenDrive, a Secure digital (SD) card, a Multi-media card (MMC), and a flash drive.

Preferably, the protected memory block further includes a hidden area for storing the key code.

Certainly, the encrypted contents can be encrypted according to Advanced Encryption Standard (AES), Data Encryption Standard (DES), and Triple-DES.

Preferably, the OS limiter is capable of disabling “print screen” key on a keyboard, or deactivating application program interfaces (APIs) of “copy”, “paste”, “save” and “save as” of the OS.

It is another object of the present invention to provide a security method for a content card, wherein the content protection program with a decryption AP and OS limiter is introduced into a memory card and executed to either allow or prevent data to flow between the memory card and the computer while the memory card is plugged in a computer, is capable of protecting the contents of memory cards and achieving the purpose of providing the memory cards with entire security, and can rectify those drawbacks of the prior art and solve the above problems.

In accordance with another aspect of the present invention, the security method for a memory card includes the steps of: a) plugging the memory card containing contents encrypted with a key code stored in the memory card into a computer installed with an OS; b) verifying if an identification code exclusive for the memory card is authentic; c) loading a content protection program from the memory card if the identification code is authentic; d) executing content protection program; e) decrypting the encrypted contents by the key code; f) disabling predetermined functions of the OS; and g) unloading the content protection program.

Preferably, the content protection program comprises a decryption AP for performing step e).

Preferably, the content protection program comprises an OS limiter for performing step f).

Preferably, memory card comprises a protected memory block having a hidden area for storing the key code and a public area for storing the encrypted contents, respectively.

Preferably, the contents are encrypted in accordance with Advanced Encryption Standard (AES), Data Encryption Standard (DES), and Triple-DES.

Preferably, the memory card comprises a USB PenDrive, a SD card, a MMC, and a flash drive.

Certainly, the content protection program and the key code can be pre-loaded to the memory card by steps of: a1) plugging the memory card into a production computer; a2) executing an encryption AP on the production computer to generate the key code; a3) encrypting the contents by the key code to obtain the encrypted contents; a4) storing the key code and the encrypted contents into the memory card; and a5) saving the content protection program into the memory card.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates a secure flash memory device according to the prior art;

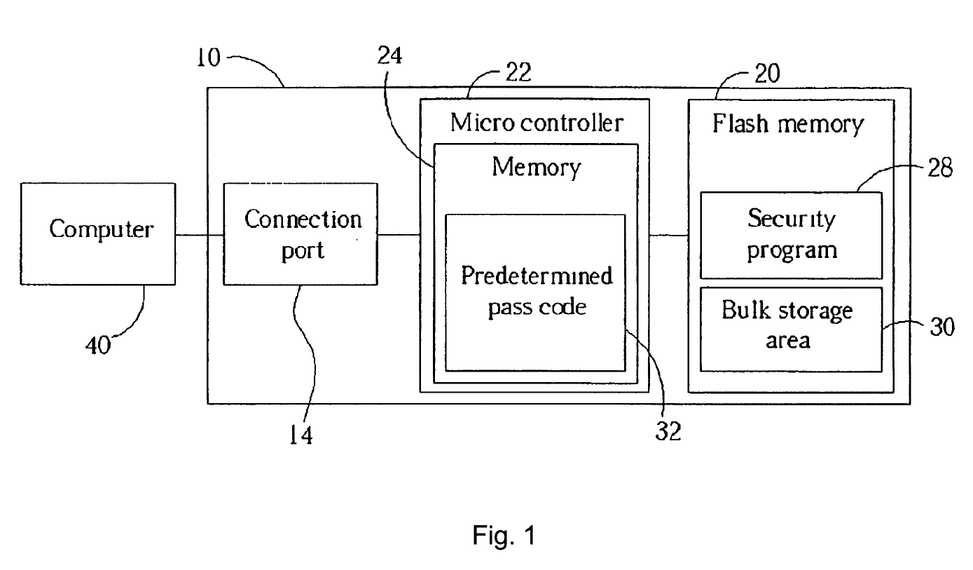

FIG. 2 illustrates a preferred embodiment of a memory card for use with a computer installed with an OS according to the present invention;

FIG. 3 illustrates steps of a preferred embodiment of a security method for a memory card according to the present invention; and

FIG. 4 illustrates steps of pre-loading the content protection program and the key code to the memory card according to the present invention.

### DETAILED DESCRIPTION OF THE PREFERRED EMBODIMENT

The present invention discloses a memory card and a security method for application in the same. The objects and advantages of the present invention will become more readily apparent to those ordinarily skilled in the art after reviewing the following detailed description. The present invention needs not be limited to the following embodiment.

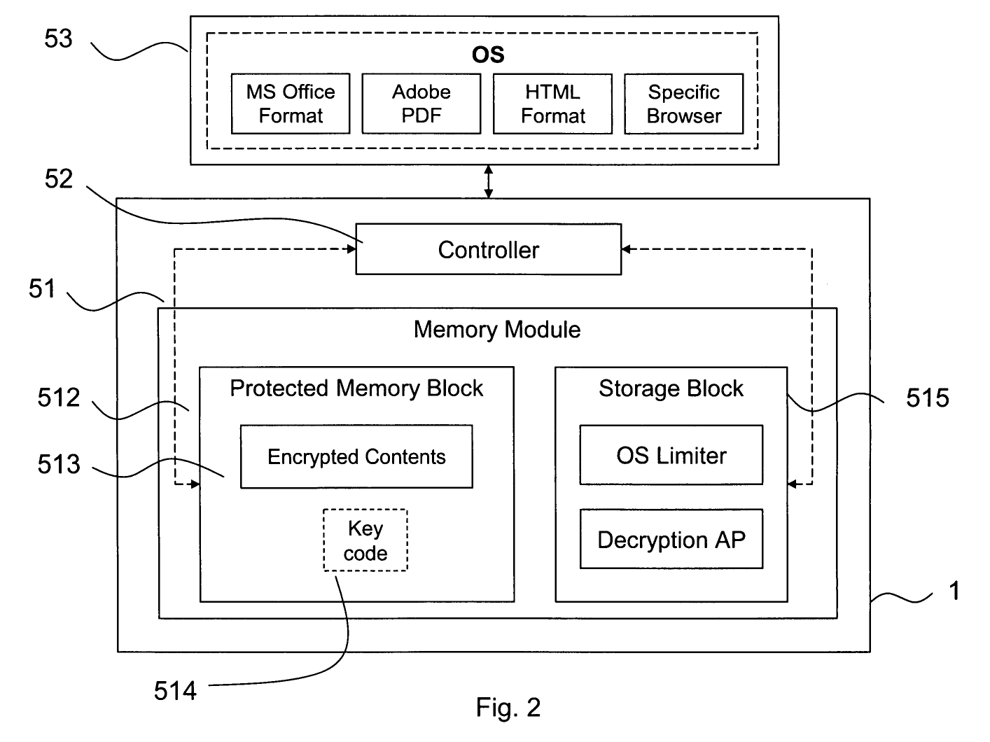

Please refer to FIG. 2. It illustrates a secure architecture of a memory card connected to a computer installed with an OS according to the present invention. As shown in FIG. 2, a memory card 1 encompasses a memory module 51 and a controller 52 for communication between a host computer 53 installed with an OS and the memory card 1. The memory module 51 includes a protected memory block 512 and a storage block 515. The protected memory block 512 further encompasses a public area 513 and a hidden area 514 for storing encrypted contents and key code respectively. The storage block 515 contains a content protection program (not shown) including a decryption AP. After the memory card 1 is connected to a host computer 53, the controller 52 immediately sends a request to the memory module 51 to launch the content protection program of the storage block 515 to the OS, and the decryption AP is released and executed on the OS accordingly. Therefore, the OS 53 is capable of accessing the memory module 51 and outputting the encrypted contents 513 to a number of readers, such as MS Office® and the like, after the decryption AP is load and executed onto the OS and retrieves the key code from the hidden area 514 of protected memory block 512.

Additionally, a content protection program stored in the memory card may further include an OS limiter for disabling predetermined functions of the OS after the OS limiter is loaded to the OS. In practice, the memory card could be a USB PenDrive, a SD card, a MMC, and a flash drive. In other words, the security system of the present invention could be applied in a USB PenDrive, a SD card, a MMC, and a flash drive. Meanwhile, the protected memory block 512 could store the key code in a hidden area 514 for eliminating chances that key code being located, invaded or cracked, and the encrypted contents stored in a public area 513 of the protected memory block 512. The encrypted contents can be encrypted in accordance with Advanced Encryption Standard (AES), Data Encryption Standard (DES), and Triple-DES. On the other hand, after decryption AP is loaded to the OS, the encrypted contents can be decrypted by the decryption AP while OS limiter is activated to limit some functions of the OS, thereby enabling the readout of the encrypted contents under the protection of the content protection program. Meanwhile, the OS limiter is capable of disabling “print screen” key on a keyboard, or deactivating application programming interfaces (APIs) of “copy”, “paste”, “save” and “save as” of the OS. According to the present invention, the encrypted contents in the public area 513 of the protected memory module 512 can be decrypted, output and browsed through various readers, such as MS Office®, PDF, HTML, and the like; however, further copy and modification operations are prohibited.

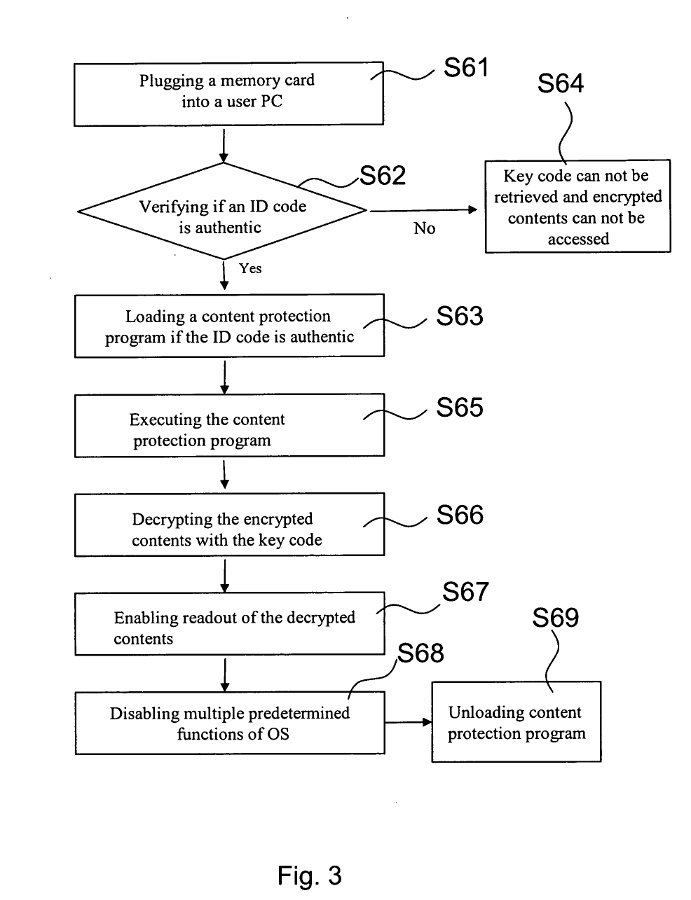

Please refer to FIG. 3. It illustrates a preferred embodiment of a security method for a memory card according to the present invention. The first step is to plug the memory card 1 containing contents encrypted with a key code stored in the memory card 1 into a host computer 53 installed with an OS, as shown in step S61 of FIG. 3. Once the memory card 1 is connected to the host computer 53, the verifying procedure would be initiated to confirm if an identification code exclusive for the memory card 1 is authentic, as shown in step S62 of FIG. 3. If the identification code is proven authentic and consequently passes the verifying procedure, a content protection program in the storage block 515 of the memory module 51 will be released to the OS of an host computer 53, as shown in step S63 of FIG. 3; otherwise, step S62 will proceed to step S64 of FIG. 3 instead. Namely, the controller 52 won't be notified to launch a request to the storage block 515 of memory module 51 to release content protection program to the OS. However, the identification code verifying procedure is optional. The step S61 of FIG. 3 would directly proceed to S63 in such a case. Thus, the key code remains in the hidden area 514 of the protected memory block 512, and the encrypted contents remain encrypted. When the OS automatically detects that the content protection program successfully loaded and executed, decryption AP and OS limiter are activated accordingly, as shown in step S65 in FIG. 3. Subsequently, the activated decryption AP retrieves the key code in the hidden area 514 of the protected memory block 512 and decrypts the encrypted contents with the key code, as shown in step S66 of FIG. 3, contributing to the readout of the decrypted contents at step S67 of FIG. 3. However, following step S67, the OS limiter disables the predetermined functions of the OS at step S68 of FIG. 3, such that the decrypted contents cannot be duplicated or further output to a printer or the like since multiple APIs functions are now deactivated, provided that someone other than the legitimate user manages to further copy or tamper with the contents. At the last step S69 of FIG. 3, the OS resumes its predetermined functions and the encrypted contents remain private in the protected memory block 512 when the content protection program is unloaded.

Similarly, the memory card can be a USB PenDrive, a SD card, a MMC, and a flash drive. Moreover, the OS limiter is capable of disabling “print screen” key on a keyboard, or deactivating application program interfaces (APIs) of “copy”, “paste”, “save” and “save as” of the OS as in step S67 of FIG. 3. The encrypted contents are encrypted according to Advanced Encryption Standard (AES), Data Encryption Standard (DES), and Triple-DES.

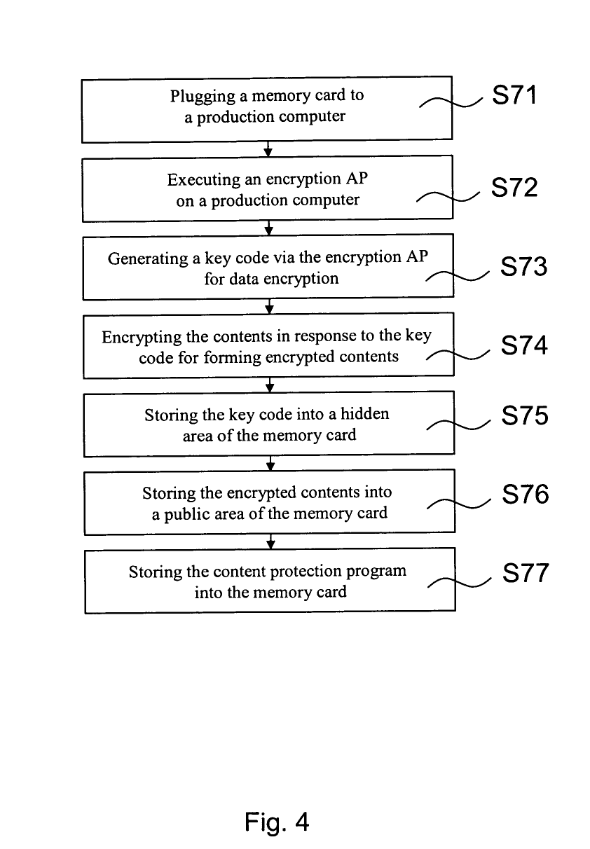

More particularly, the content protection program and the key code can be preloaded to the memory card. Please refer to FIG. 4. Firstly, the memory card is plugged into a production computer at step S71. Then, an encryption AP would be automatically executed on a production computer to generate the key code, as shown in steps S72 and S73. The role of the key code is for data encryption and preventing unauthorized access to the private content. Following step S73, the contents are encrypted by the newly-generated key code to obtain the encrypted contents at step S74. Besides, the protected memory block of the memory module is divided into several areas, among which the key code and the encrypted contents are stored respectively in the hidden area and the public area, as shown in steps S75 and S76. Next, the content protection program is saved into the storage block of memory card at step S77. The entire preloading operation comes to an end after performing S71 to S77.

In conclusion, the present invention provides a memory card and a security method therefor that dramatically enhance overall security of the private digital contents by ensuring that transitory data stored in memory remains private and encrypted by a key code by means of engaging the content protection program with a decryption AP for retrieving the key code and OS limiter for disabling multiple APIs of the predetermined functionality of an OS to a memory card. Differentiated from the prior art allowing arbitrary read or other further operations, the present invention eliminates the prior potential security holes by prohibiting malicious duplication and output of the private contents stored in the memory card, thereby achieving the purpose of providing the memory cards armed with comprehensive security facilities, and can rectify those drawbacks of the prior art and solve the above problems.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A memory card for use with a computer installed with an operating system (OS), comprising:
a first memory area for storing a key code;
a second memory area for storing contents encrypted with said key code; and
a third memory area for storing a content protection program including a decryption application program (AP) for decrypting said encrypted contents after said decryption AP is loaded to said OS.

2. The memory card according to claim 1, wherein a content protection program further includes an OS limiter for disabling predetermined functions of said OS after said OS limiter is loaded to said OS.

3. The memory card according to claim 1, wherein said first memory area is a hidden area.

4. The memory card according to claim 1, wherein said contents are encrypted in accordance with Advanced Encryption Standard (AES), Data Encryption Standard (DES), and Triple-DES.

5. The memory card according to claim 1, wherein said OS limiter is capable of disabling “print screen” key on a keyboard, or deactivating application program interfaces (APIs) of “copy”, “paste”, “save” and “save as” of said OS.

6. The memory card according to claim 1, wherein said memory card comprises a USB PenDrive, a SD card, a MMC, and a flash drive.

7. A security method for a memory card, comprising the steps of:
a) plugging said memory card containing contents encrypted with a key code stored in said memory card into a host computer installed with an OS;
b) verifying if an identification code exclusive for said memory card is authentic;
c) loading a content protection program from said memory card if said identification code is authentic;
d) executing said content protection program;
e) decrypting said encrypted contents by said key code; and
f) unloading said content protection program.

8. The security method according to claim 7, wherein said content protection program comprises a decryption AP for performing step e).

9. The security method according to claim 7, wherein said content protection program comprises an OS limiter for disabling predetermined functions of said OS.

10. The security method according to claim 7, further comprising before step a) the steps of:
a1) plugging said memory card into a production computer;
a2) executing an encryption AP on the production computer to generate said key code;
a3) encrypting said contents by said key code to obtain said encrypted contents;
a4) storing said key code and said encrypted contents into said memory card; and
a5) saving said content protection program into said memory card.

11. The security method according to claim 7, wherein said memory card comprises a storage space having a hidden area for storing said key code and a public area for storing said encrypted contents, respectively.

12. The security method according to claim 7, wherein said contents are encrypted in accordance with Advanced Encryption Standard (AES), Data Encryption Standard (DES), or Triple-DES.

13. The security method according to claim 9, wherein said OS limiter is capable of disabling “print screen” key on a keyboard, or deactivating APIs of “copy”, “paste”, “save” and “save as” of said OS.

14. The security method according to claim 7, wherein said memory card comprises a USB PenDrive, a SD card, a MMC, and a flash drive.

15. A security method for a memory card, comprising the steps of:
a) plugging said memory card containing contents encrypted with a key code stored in said memory card into a host computer installed with an OS;
b) loading a content protection program from said memory card;
c) executing said content protection program;
d) decrypting said encrypted contents by said key code;
e) unloading said content protection program.

16. The security method according to claim 15, wherein said content protection program comprises a decryption AP for performing step d).

17. The security method according to claim 15, wherein said content protection program comprises an OS limiter for disabling predetermined functions of said OS.

18. The security method according to claim 15, further comprising before step a) the steps of:
a1) plugging said memory card into a production computer;
a2) executing an encryption AP on the production computer to generate said key code;
a3) encrypting said contents by said key code to obtain said encrypted contents;
a4) storing said key code and said encrypted contents into said memory card; and
a5) saving said content protection program into said memory card.

19. The security method according to claim 15, wherein said memory card comprises a storage space having a hidden area for storing said key code and a public area for storing said encrypted contents, respectively.

20. The security method according to claim 15, wherein said contents are encrypted in accordance with Advanced Encryption Standard (AES), Data Encryption Standard (DES), or Triple-DES.

21. The security method according to claim 15, wherein said memory card comprises a USB PenDrive, a SD card, a MMC, and a flash drive.
